(19) United States
(12) Patent Application Publication
(10) Pub. No.: US 2001/0047396 A1
(43) Pub. Date: Nov. 29, 2001

(54) Method for identifying information in a network

(76) Inventors: Jacob Nellemann, Birkerod (DK); Niels Skjoldager, Valby (DK)

Correspondence Address: BIRCH STEWART KOLASCH & BIRCH, PO BOX 747, FALLS CHURCH, VA, 22040-0747, US

(21) Appl. No.: 09/772,916

(22) Filed: Jan. 31, 2001

Related U.S. Application Data
(60) Provisional application No. 60/179,146, filed on Jan. 31, 2000.
(60) Provisional application No. 60/189,146, filed on Mar. 14, 2000.

(51) Int. Cl. G06F 15/16

(52) U.S. Cl. 709/217; 709/245

(57) ABSTRACT

The present invention relates to the situation where URL information is executed with the purpose of accessing a given document on the Internet. The URL information is automatically used to generate a search-engine database query as well as the execution of the URL request.

### The present invention relates to a method for identifying information in a network. In particular, the present invention relates to a method for showing a result of a search from the Internet on a computer. More particularly, the present invention relates to a method for generating a database query and result based on information as provided for a URL request in one or more computers in a network, such as the Internet.

### BACKGROUND OF THE INVENTION

An essential use of computers is the transfer of information over a network. Currently, the largest computer network in existence is the Internet, which is a worldwide interconnection of millions of computers, e.g. from wireless devices such as Internet enabled mobile phones and Personal Data Assistants to personal computers to mainframes.

The Internet grew out of work funded in the 1960s by the U.S. Defense Department's Advanced Research Projects Agency. The Internet was originally used to share information on a network and was mainly used by researchers, primarily in universities and national laboratories. As the existence of the Internet became more widely known many users outside of the academic and research communities started to use the Internet to carry electronic mail. In 1989, researchers at CERN developed an information system known as the World Wide Web (“the Web” or “www”). The Web is a wide-area hypermedia information retrieval system designed to give universal access to a large universe of electronically stored documents.

On the Internet a local computer or device that is capable of connecting to the Internet can connect to a distant server, request a file, document or an image from the server, and receive the requested information immediately.

The Internet operates according to several standard protocols. For example, packets of data are communicated among Internet host computers (“servers”) using the Transmission Control Protocol (TCP) and Internet Protocol (IP).

Each server that is accessible using the Internet or connected to the Internet is associated with a unique numeric identifier called an IP address. Each IP address consists of numeric parts. An example IP address is “204.93.112.93”. The IP addresses are assigned and managed by a central Internet Assigned Names Authority. Numeric identifiers are rapidly and conveniently processed by computers, but are inconvenient for humans to remember and type.

Accordingly, in 1984 the Domain Name System (DNS) was introduced. DNS is a distributed information database that maps the IP address of a server to a host name or “domain name”. For example, the domain name www.hothothot.com could be mapped to the IP address 255.96.342.4 in the DNS system. The database is available at several computer systems around the world known as DNS servers. A local computer can look up a remote server by connecting to a DNS server, providing a domain name to the DNS server, and obtaining the IP address that corresponds to the domain name. The local computer can then connect to the remote computer using the IP address, and send and receive information.

Generally domain names comprise two or more alphanumeric fields, separated by periods. The right-most field is the generic top-level domain (gTLD) name. The “com” portion of the domain name “infonizer.com” is a generic top-level domain name that indicates that “infonizer.com” is a commercial domain. Other gTLD's include “dk” (for Danish domains), “gov” (for government domains), and “info” (for domains of informational entities). Still other gTLDs have been proposed for creation.

The “infonizer” portion of “infonizer.com” is a second level domain name or organization name. Usually the second level domain name is also the name of a specific network server or host at the institution that owns the domain name. Domain names also can have third-level domain names, such as “www”, that identify a sub-domain of the organization, such as a sub-directory of the network server, or a specific computer or workstation.

Domain names may also incorporate geographic portions. An example is the domain name “wap.infonizer.co.dk”. The “dk” portion indicates Denmark; the “co” portion refers to the organization being a company; “infonizer” is the organization name; and “wap” is the sub-domain. In some nations, such as the United States, the order of these elements can be reversed.

One popular technology enjoying wide use with the Internet is known as the World Wide Web. The World Wide Web enables a computer to locate a remote server using the DNS and then establish a connection to the server and retrieve information using a communication protocol called the Hypertext Transfer Protocol (HTTP). Each item of information available using the Web, including files, images, or pages, is called a resource. A Uniform Resource Locator (URL) uniquely identifies each resource stored on a server. A URL is a form of network address comprising a domain name coupled to an identifier of the location of information stored in a network,

An example of a URL is http://www.infonizer.com/index.html. In this example, “http://” indicates that the information associated with the URL can be accessed using HTTP; www.infonizer.com identifies the server that is storing the information; and “index.html” identifies a file or document on that server.

The local computer requests information by providing a request containing a URL of the desired information to the remote server. The server receives the request, locates the page of information corresponding to the URL, and returns the page to the local computer over the HTTP connection. The pages of information are files in stored in computer languages such as the Hypertext Markup Language (HTML) or corresponding languages such as eXtensible Markup Language (XML) or Wireless Markup Language (WML) all transferable through a HTTP connection. The local computer runs a browser program that can read the computer language files, interpret the computer language codes in the files, and generate a complex graphical display.

A location identifier or URL references web pages in the DNS system. The current DNS system as implemented with the Web has several disadvantages and drawbacks. Although the DNS system ensures that each URL is unique across the Web, URLs are difficult to remember and associate with a particular institution, person, or product related to the owner of the domain or page associated with the URL. For example to locate a page of information about the Hawaiian surfing conditions, in the current system a user must enter a complex URL into the browser, such as http://www.hawaii.com/activities/surfing/# views.

Thus, an inherent disadvantage of the DNS system is that the user must know the exact location and name of the desired information.

Further, the network address must be typed correctly every time or the resource will not be found. The format of URLs is complex and unpredictable. Errors are hard to spot. Addresses are difficult to guess.

Electronic searching by generating a query phrase is commonly used for searching databases. With the expanded use of the Internet and the World Wide Web, query based searching has expanded to encompass file systems, databases and other data collections accessible over the Internet. The unit retrieved as a hit from a query is referred to herein as a document. On the Web, a document often is referred to as a page or web page. The term document as used herein, includes files (as per the Windows operating system usage), documents (as per the MacOS operating system usage), pages (as per the web phraseology usage), and other records, entries or terminology used to describe a unit of a data base, a unit of a file system or a unit of another data collection type, whether or not such units are related or relational.

Search engines are commonly used to search the Internet. The user specifies search criteria and search engines generate a query phrase based hereon, which is used to search a database for the desired document (web page having a Uniform Resource Locator).

A hyperlink can be defined as a network address embedded in a word, phrase, icon or picture (a program object representation) that is activated when selected - usually by clicking the link with a mouse or similar pointing device. Information about that item is currently retrieved by the use of a Web browser.

The World Wide Web made it easier for users to jump from one server to another simply by selecting a hyperlink. Users are therefore able to access documents on the Internet directly by clicking on a hyperlink in which case it is not necessary to manually type in a URL in a browser.

Executing a URL in a browser can lead the user to the desired document containing the wanted content. It can also lead to the desired document but not containing the desired content. Entering a faulty URL, whether that be misspelled or via a broken hyperlink, the user is not lead to the desired document and is therefore not showing the desired content. An alternative URL may lead to the desired document containing the desired content.

To access a given document on the Internet the user can either manually enter URL information in a browser or alternatively use a hyperlink or a suggested URL in the browser used.

Potential problems occur if

a) the user does not have the correct URL address to manually enter and execute in a browser, or

b) the user does not have access to a hyperlink leading to the desired document, or

c) the URL is valid but does not lead to the desired document, or

d) the URL address is not entered appropriately, this being either due to a broken hyperlink, misspelling or due to the entering of an expected correct URL address, that later turns out to be incorrect.

The following lists the methods the user traditionally has available to search the Internet to find a desired document:

1. A URL is entered manually or through a hyperlink in a browser and executed:

a) The user is lead to a desired document containing the desired content

b) The user is lead to a desired document but not the desired content

c) The URL does not lead to a desired document - error

d) The URL leads to a document that does not contain the desired content

2. If the URL does not lead to a desired document (1c) & (1d):

a) The user executes altered URL in a browser with the purpose of obtaining the desired document

b) The user executes URL to access a search-engine

c) The user engages a search function in a browser

d) An alternative URL is executed in a browser

3. If the URL leads to a desired document but not the desired content:

a) The user executes an URL to access a search-engine

b) The user engages a search function in a browser

c) An alternative URL is executed in a browser

If the URL does not lead to a desired document the user can possibly access a desired document by executing an altered URL in a browser (2a), or executing an URL to access a search-engine (2b), or engaging a search function in a browser such as the search function in a known browser, such as Microsoft Explorer or Netscape Navigator, or executing an alternative URL in a browser.

If the URL leads to a desired document but not a desired content the user can possibly access a desired content by executing an URL to access a search-engine (3a)), or engaging a search function in a known browser (3b)), or by executing an alternative URL in a browser.

In the case of using a search-engine the user has to as step 1 enter and execute a URL in a browser to access the search-engine, then as step 2 enter search-criteria in the search-engine, then wait for the search-engine to complete the search and display the search-result.

In the case of using a search-function in a known browser such as Microsoft Explorer or Netscape browser, the user as step 1 has to engage the “search-function” and then wait for the search-function to complete a search based on the URL given in the browser. However, this may not even lead to the desired document or the desired content in that the URL has to be entered correctly in order for the search function to generate a search-result. In the event the URL is not entered correctly, the search-function will not generate a search-result. The user must then as step 2 repeat the search process by either trying to re-enter an altered URL or executing a search-engine URL, then as step 3 enter search-criteria in the search-engine, then wait for the search-engine to complete the search and display the search-result.

In the Microsoft browser an automatic search is activated if a single word—i.e. not the complete URL—is provided. In case the Microsoft browser identifies the provided word as a part of an Internet address, that Internet address is shown to the user. In case the provided word is incorrect, the Microsoft browser is typically not capable of locating an Internet address. The browser then generates an error stating that an Internet address has not been located.

It is important to note that the above-mentioned automatic search supported by the Microsoft browser is not capable of handling a search based on a URL. If the provided word is incorrect, the search is stopped and the user is forced to manually initiate a second search. Thus, if the single word entered in the Microsoft browser is somehow incorrect, the user is forced to manually initiate a second search.

Thus, it is a disadvantage of known methods that unless the user has the correct URL information leading to a desired document and content it is cumbersome, time-consuming, and frustrating to obtain access to a desired document containing the desired content. This is due to the fact that the user has to repeat the tedious process of entering and re-entering search criteria or altered URL's in order to obtain access to a desired document containing the desired content.

It is an object of the present invention to provide a method for guiding a user quickly to a desired document in a network containing the desired information.

It is a further object of the present invention to provide a method for identifying alternative URL's if a desired document in the network is not located.

It is a still further object of the present invention to provide a method involving only a single user initiated step in order to obtain alternative URL's in a network.

The invention described in detail below gives the user a much easier way to obtain access to a desired document containing the desired information.

### SUMMARY OF THE INVENTION

The above-mentioned objects are complied with by providing, in a first aspect, a method for identifying desired information in a network, said method comprising the steps of:

a) providing a network holding or representing information at a plurality of addresses,

b) providing a URL, said URL being expected to be associated with a desired document in the network at which desired information is expected to be represented,

c) performing a first search so as to locate the desired document using the provided URL, and

d) automatically performing a second search using at least part of the provided URL in order to generate one or more URL's, each of said one or more URL's being associated with a document in the network.

The method may further comprise the step of displaying the generated URL's if the desired document is not located. Even further, the method may further comprise the step of selecting at least one of the generated one or more URL'S.

The first and second search may be performed essentially simultaneously. Alternative, the first and second search may be performed sequentially.

The network may form part of the Internet and the desired document may comprise a web page. The URL may be provided using an Internet browser. The network may comprise a client machine, a service provider and a search engine server. The client machine may initiate the first and second search.

In a second aspect, the present invention relates to a method for identifying desired information in a network, said method comprising the steps of:

a) providing a network holding or representing information at a plurality of addresses,

b) providing a URL, said URL being expected to be associated with a desired document in the network at which desired information is expected to be represented,

c) providing a browser being adapted to perform a first search so as to locate the desired document using the provided URL, and

d) providing a search engine being adapted to automatically perform a second search using at least part of the provided URL in order to generate one or more URL's, each of said one or more URL's being associated with a document in the network.

In the second aspect of the present invention the method may further comprise the step of displaying the generated one or more URL's if the desired document is not located. Even further, the method according to the second aspect may further comprise the step of selecting at least one of the generated one or more URL's. As in the first aspect of the present invention the first and second search may be performed essentially simultaneously or sequentially. The network may form part of the Internet and the desired document may comprise a web page.

### BRIEF DESCRIPTION OF THE DRAWING

The object, features and advantages of the present invention will be apparent from the following descriptions in which:

FIG. 1a and 1b illustrate exemplary network environments in which the invention may be usefully employed,

FIG. 2 shows the data-flow according to the present invention,

FIG. 3 illustrates the flow of data when the invention is used in a network,

FIG. 4 shows URL data processing according to the invention, and

FIG. 5 shows a flow-chart of an example of the usage of the invention in a process leading to a desired document on the Internet.

### DETAILED DESCRIPTION OF THE INVENTION

The detailed descriptions, which follow, may be presented in turns of program procedures executed on a computer or network of computers. These procedural descriptions and representations are the means used by those skilled in the art to most efficiently convey the substance of their work to others skilled in the art. A procedure is here, and generally, conceived to be a self-consistent sequence of steps leading to desired results. These steps are those requiring physical manipulations of physical quantities.

Usually, though not necessarily, these quantities take the form of electrical or magnetic signals capable of being stored, transferred, combined, compared, and otherwise manipulated. It proves convenient at times, principally for reasons of common usage to refer to these signals as bits, values, elements, symbols, characters, terms, numbers, data or the like. It should be noted, however, that all of these and similar terms are to be associated with the appropriate physical quantities and are nearly convenient labels applied to these quantities.

Further, the manipulations performed are often referred to in terms such as adding or comparing which are commonly associated with mental operations performed by a human operator. No such capability of a human operator is necessary, or desirable in most cases, in any of the operations described herein, which form part of the present invention; the operations are machine operations. Useful machines for performing the operation of the present invention include general-purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

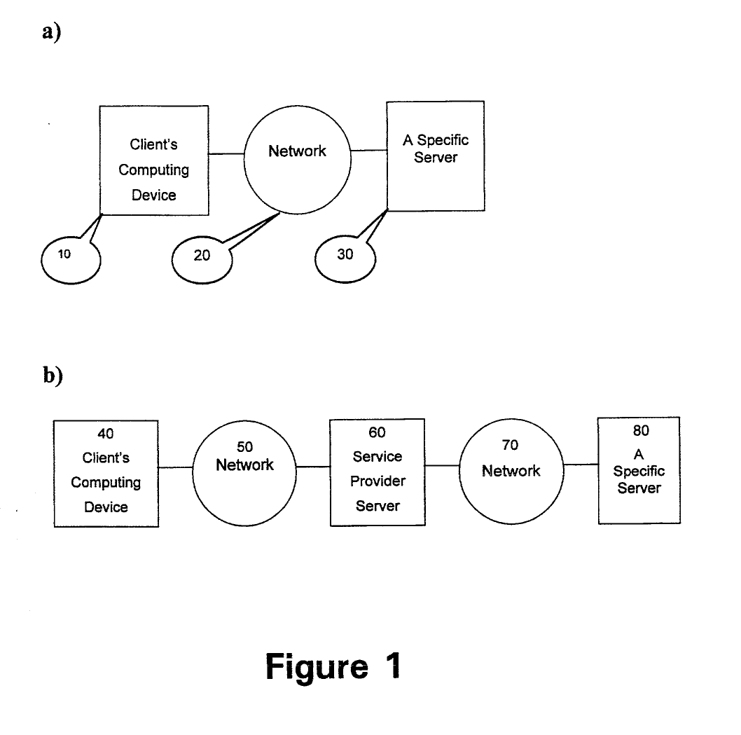

The environment in which the invention will operate is illustrated in FIG. 1a and 1b. In the simplest environment shown in FIG. 1a, the users computing device (10), running browser software, is attached to a network (20). The specific server (30) the user wants to access is attached to the same network. A more complex environment is depicted in FIG. 1b in which the users' computing device (40) is attached to a network (50) that is attached to an Internet service provider (ISP) server (60) which is, in turn, connected to another network (70) providing a connection to the specific server (80). The various components of the invention may or may not be installed at each computing device or ISP server. The client-side components could be installed on the users computing device (10 and 40), and/or on the ISP server. The server side component (search-engine) could be installed on the specific server being accessed (30 and 80).

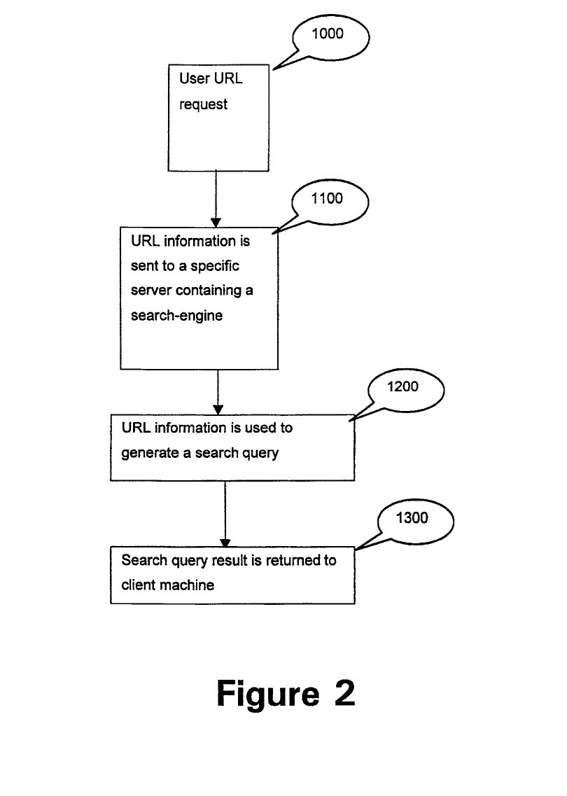

FIG. 2 shows a flow-chart of the invention. The process begins with a user URL request on a client machine (1000), either manually entered in a browser or generated from executing a hyperlink. The URL is sent via a network, such as the Internet, to a specific server containing a search-engine (1100). The URL information is used to generate a search-query (1200). The search-query result is returned via the network to the client machine (1300)

The URL information may need to be modified, filtered or added certain information in order to generate a usable search criteria, depending on the algorithm in a given search engine used to process a search query based on the URL information.

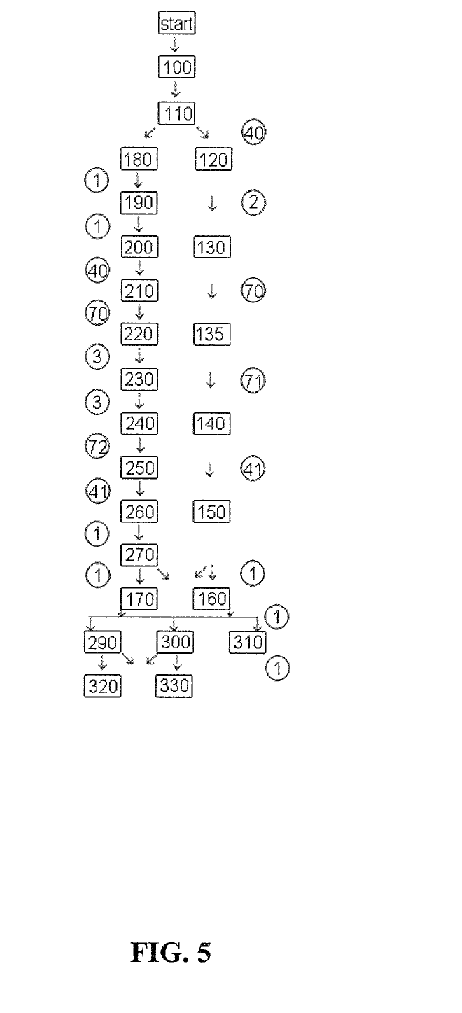

An example of this is described in FIG. 5, where:

1: Internal data processing on client computer device

2: Internal data processing on Service provider computing device

3: Internal data processing on Search Engine computing device

40: Dataflow from Client computer device to Service Provider computing device

41: Dataflow from Service provider computing device to client computer device

70: Dataflow from search engine computing device to service provider computing device

71: Dataflow concerning search for and localization of the requested URL on the Network.

100: Entry of information in URL-field in a browser on a client machine

110: User executes URL request

120: URL request is received by a service provider

130: Service provider executes request

135: Specific server answers request

140: A result of the request for a given document on a specific server is received by server provider

150: Client-machine receives the result of the request

180: Generic information from the entered URL request is filtered

190: Non-generic information is implemented in a command line in a given search engine.

200: Command line is executed

210: Command line is received by service provider

220: Search engine on specific server executes command line

230: Search-engine generates a database query based on the command line

240: Search-engine generates search result

250: The result of the search is received by the service provider

260: The result of the search is received by client machine

270: The result of the search is cached in client machine

160: The requested document is displayed on the client machine

170: The requested document is not identified and the requested document is not displayed

290: The cached search result is displayed automatically on the client machine

300: The cached search result can be displayed at users will

310: A document containing the “closest match” to the desired URL request is displayed automatically

320: User can execute a hyperlink and thereby gain access to alternative documents

330: User can execute a hyperlink and gain access to a document containing the “closest match”

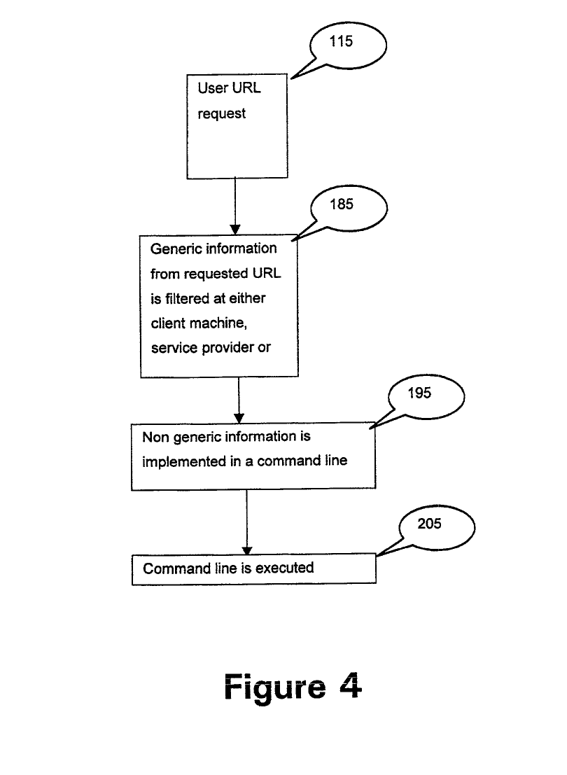

FIG. 4 is an example of how URL information is used to generate a search-engine database query. The process begins with the users' request of a URL (115). The invention then separates information from the URL, which is not necessary to perform a search-engine database query (185). Examples of separation of the URL can be distinguished between protocol, domain, punctuation, extension information. For instance the URL http://www.uspto.net/patft.images.htm can be separated into http, :, //, www, ., uspto, ., net, /, patft, ., images, ., htm. The information used in the query is defined to be uspto, net, patft, images. The invention implements (195) this information in a command-line for a specific search-engine. Using the example above the information used for the command-line could be “uspto net patft images”. After implementing the information in a command-line the command-line is executed parallel with the execution of the URL request. The separation of URL-information can be performed on the client machine, on the service provider server or on the specific server, e.g. search-engine (185).

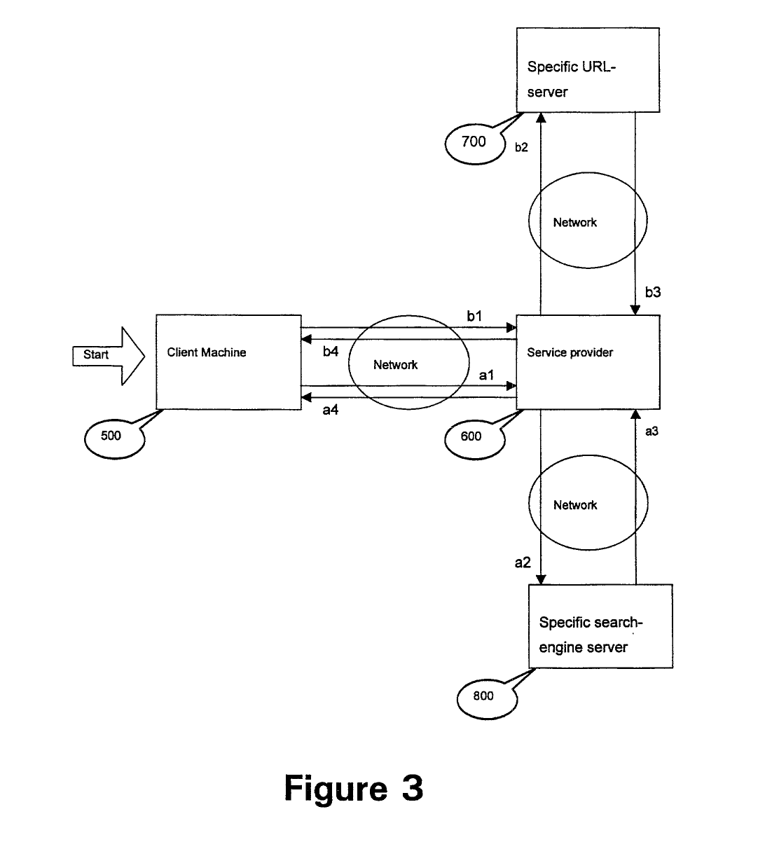

FIG. 3 shows a chart of the flow of data when the invention is used in a network, such as the Internet. Upon the user request of the URL on the client machine (500), the invention implements the URL into two processes establishing two distinctive data-flows. These two processes are carried out automatically—e.g. simultaneously or sequentially.

The two data-flows (a) (b) are executed by the user only having to make one action: The normal execution of a URL request (data flow b1 to b4), for example by entered a URL in a browser or executing a hyperlink.

The following describes each of the two processes separately.

Data-flow b1 to b4:

The regular URL request process (b) is transmitted (b1) through a network to a service provider (600). The service provider forwards (b2) the URL request and attempts to locate the URL on a specific server (700), successful or not. The specific server (700) transmits (b3) the result of the inquiry to the service provider (600), which in turn transmits (b4) the result of the URL request to the client machine (500).

Data-flow a1-a4:

The invention transmits (a1) the URL-data (now used with purpose of generating a search-engine database query and thus taking the form of a useful search criteria) to a service provider (600) from a client machine (500). The service provider (600) transmits (a2) the URL-data to a specific search-engine server (800). The URL-data is used to perform a search-query on the specific search-engine server (800). The search result is transmitted (a3) to a service provider (600), which in turn transmits (a4) the search result to the client machine (500).

FIG. 5 provides a flowchart and diagram to demonstrate the preferred embodiment of the invention in a network.

FIG. 5 provides a flowchart of an example of the usage of the invention in a process leading users to the desired document on the Internet. The process begins when the user requests a certain document by entering (100) a URL in a browser that be either manually or through a hyperlink. The user executes the document request (110). The document request is transmitted to a service provider (40). At the same time the document request is executed, the invention uses the URL information to generate a search engine database query, which is done by removing all generic information from the URL (180).

This can be done either on the client side (1), service provider side (not shown in FIG. 5) or on a specific server, e.g. a search-engine (not shown in FIG. 5). Remaining information is implemented in a search-engine command line (190), which is executed (200) at the same time as the document request is executed from a web browser (110). The invention then transmits the search-engine command line (40) to a service provider (210), which in turn sends (70) the search-engine command line to a search-engine on a specific server (220). The search-engine generates (3) a database query based on the information in the search-engine command line (230). The search-engine database query result (240) is then transmitted (72) to a service provider (250). The service provider sends (41) the database query result to the client computing device (260). This document is cached (1) in the clients computing device (270).

As the URL request is executed (110) the URL request is sent (40) to the service provider (120). The service provider executes (2) the document request (130). The request is deployed on the Internet (70) by searching the Internet for the specific URL and thus a specific server (135). The result of the document request is sent (71) to the service provider (140), which in turn is sent (41) to the client computing device (150). The result of the document request is shown (1) on the client computing device (160 or 170).

If the requested document is not displayed on the client machine (170) or if the requested document does not contain the desired content (160) the user has multiple options:

Option 1

The cached search result (270) is displayed automatically on the client machine (290). In turn the user has the option of: Either executing a hyperlink (320) and thereby gain access to alternative documents based on the search-engine query with the possibility of obtaining the desired content, or executing a hyperlink (330) gaining access to a document displaying the closest match to the requested URL (100).

Option 2

The cached search result (270) can be displayed at users will on the client machine (300). In turn the user has the option of: Either executing a hyperlink (320) and thereby gain access to alternative documents based on the search-engine query with the possibility of obtaining the desired content, or executing a hyperlink (330) gaining access to a document displaying the closest match to the requested URL (100).

Option 3

The cached search result (270) is automatically displayed on the client machine (310). The parallel execution of the invention and the URL request on the Internet leads to the option of directly accessing a given alternative or same document as the requested based on a single URL user request, thereby easily leading the user to the desired content. A search-engine query will be available to the user based on one URL request (one action performed by the user) regardless of the URL request leads to the desired document and content or not. This leads to fewer user-intervened actions and easier access to Internet documents based upon only one URL request.

1. A method for identifying desired information in a network, said method comprising the steps of:
a) providing a network holding or representing information at a plurality of addresses,
b) providing a URL, said URL being expected to be associated with a desired document in the network at which desired information is expected to be represented,
c) performing a first search so as to locate the desired document using the provided URL, and
d) automatically performing a second search using at least part of the provided URL in order to generate one or more URL's, each of said one or more URL's being associated with a document in the network.

2. A method according to claim 1 further comprising the step of displaying the generated URL's if the desired document is not located.

3. A method according to claim 2 further comprising the step of selecting at least one of the generated one or more URL's.

4. A method according to claim 1, wherein the first and second search is performed essentially simultaneously.

5. A method according to claim 1 wherein the first and second search is performed sequentially.

6. A method according to claim 1, wherein the network forms part of the Internet.

7. A method according to claim 1, wherein the desired document comprises a web page.

8. A method according to claim 1, wherein the URL is provided using an Internet browser.

9. A method according to claim 1, wherein the network comprises a client machine, a service provider and a server containing a searchable database.

10. A method according to claim 9, wherein the client machine initiates the first and second search.

11. A method for identifying desired information in a network, said method comprising the steps of:
a) providing a network holding or representing information at a plurality of addresses,
b) providing a URL, said URL being expected to be associated with a desired document in the network at which desired information is expected to be represented,
c) providing a browser being adapted to perform a first search so as to locate the desired document using the provided URL, and
d) providing a search engine being adapted to automatically perform a second search using at least part of the provided URL in order to generate one or more URL's, each of said one or more URL's being associated with a document in the network.

12. A method according to claim 11 further comprising the step of displaying the generated one or more URL's if the desired document is not located.

13. A method according to claim 12 further comprising the step of selecting at least one of the generated one or more URL's.

14. A method according to claim 11, wherein the first and second search is performed essentially simultaneously.

15. A method according to claim 11, wherein the first and second search is performed sequentially.

16. A method according to claim 11, wherein the network forms part of the Internet.

17. A method according to claim 11, wherein the desired document comprises a web page.
